(19) United States
(12) Patent Application Publication
(10) Pub. No.: US 2023/0156873 A1
(43) Pub. Date: May 18, 2023

(54) ELECTROMAGNETIC-INDUCTION HEATING DEVICE FOR THIN-FILM THERMOCOUPLE ON CERAMIC BLADE

(71) Applicant: Xi'an Jiaotong University, Xi'an (CN)

(72) Inventors: Zhongkai ZHANG, Xi'an (CN); Bian TIAN, Xi'an (CN); Hao LI, Xi'an (CN); Bingfei ZHANG, Xi'an (CN); Libo ZHAO, Xi'an (CN)

(21) Appl. No.: 18/150,013

(22) Filed: Jan. 4, 2023

(30) Foreign Application Priority Data
Feb. 24, 2022 (CN) 202210178223.1

(51) Int. Cl. H05B 6/10

(52) U.S. Cl. CPC H05B 6/10

(57) ABSTRACT

Disclosed is an electromagnetic-induction heating device for a thin film thermocouple on a ceramic blade, including a spiral coil. The ceramic blade is enveloped in the spiral coil, and two ends of the spiral coil are both connected to an electromagnetic-induction heater. The ceramic blade is arranged in an alumina ceramic chamber, and the thin-film thermocouple is arranged on a surface of the ceramic blade. One end of the air channel is connected to an end of the alumina ceramic chamber, and the other end of the air channel is connected to an infrared nod temperature instrument and a vacuum pump. The infrared nod temperature instrument, the electromagnetic-induction heater, and the vacuum pump controller are electrically connected to the controller.

### CROSS-REFERENCE TO RELATED APPLICATIONS

This application claims the benefit of priority from Chinese Patent Application No. 202210178223.1, filed on Feb. 24, 2022. The content of the aforementioned application, including any intervening amendments thereto, is incorporated herein by reference in its entirety.

### TECHNICAL FIELD

This application relates to engine blade testing and thin-film thermocouple sensor manufacturing, and more particularly to an electromagnetic-induction heating device for a thin-film thermocouple on a ceramic blade.

### BACKGROUND

Engine blades always operate under severe conditions, such as high temperature, high pressure, high vibration, high speed, and high aerodynamic load, and their malfunction directly affects the aircraft safety. Since metal turbine blades usually operate at a temperature close to its limit, over-temperature failures often occur. CMC-SiC blade is an emerging blade featuring high melting point. For this blade, surface temperature parameters are required for design improvement and performance testing. Regarding the conventional temperature measurement methods, thermocouple wires or optical fibers are needed to be pre-buried in slots, which will damage the blade surface structure, thus affecting the flow field. By fabricating an integrated thin-film thermocouple on the ceramic blade surface, the temperature parameters can be acquired in situ without disturbing the flow. However, a high-temperature heat treatment is required for the preparation of thin-film thermocouples and the activation of thermoelectric properties thereof. Traditional heat treatment devices, such as high-temperature furnaces, will cause thermal expansion and oxidation of the blade, rendering the service performance test results inaccurate.

### SUMMARY

An object of the present disclosure is to provide an electromagnetic-induction heating device for a thin-film thermocouple on a ceramic blade to overcome the aforementioned deficiencies that the existing heating devices will pose a large thermal effect on the blade structure, affecting the accuracy of subsequent service performance test.

Technical solutions of the present disclosure are described as follows.

The present disclosure provides an electromagnetic-induction heating device for a thin-film thermocouple on a ceramic blade, comprising:

a spiral coil;

an alumina ceramic chamber;

an air channel;

an infrared temperature detector;

an electromagnetic-induction heater;

a controller; and

a vacuum pump;

wherein the ceramic blade is enveloped in the spiral coil; two ends of the spiral coil are both connected to the electromagnetic-induction heater; the ceramic blade is arranged in the alumina ceramic chamber; the thin-film thermocouple is arranged on a surface of the ceramic blade; a first end of the air channel is connected to an end of the alumina ceramic chamber, and a second end of the air channel is connected to the infrared nod temperature instrument and the vacuum pump; and the electromagnetic-induction heater, the infrared nod temperature instrument and the vacuum pump are all electrically connected to the controller.

In an embodiment, an axial length of the spiral coil is the same with a length of the ceramic blade, and an inner diameter of the spiral coil is offset such that the ceramic blade is completely enveloped in the spiral coil, which can avoid heat convection between the heated part and air and thus rendering the heating temperature stable.

In an embodiment, a gap is provided between the spiral coil and the ceramic blade to avoid short circuit caused by direct contact.

In an embodiment, the gap is 2±0.1 mm, which can avoid excessive attenuation of the electromagnetic field.

In an embodiment, the spiral coil is arranged in the alumina ceramic chamber, which avoids the occurrence of short circuits during the induction heating process due to the high-temperature insulation characteristic of alumina ceramics.

In an embodiment, the spiral coil and the alumina ceramic chamber are integrally formed by pressing molding such that there is no clearance between the spiral coil and the alumina ceramic chamber to avoid air infiltration.

In an embodiment, the alumina ceramic chamber is cylindrical; a length of the alumina ceramic chamber is the same as the axial length of the spiral coil, and an inner diameter of the alumina ceramic chamber is the same as an outer diameter of the spiral coil, such that the spiral coil is prevented from being exposed to air, and the spiral coil and the alumina ceramic chamber will not undergo oxidation owing to the excellent high-temperature chemical stability of the alumina ceramic.

In an embodiment, the ceramic blade is a stator blade made of ceramic matrix composite-SiC (CMC-SiC) to reach the excellent high-temperature resistance and high electrical resistance.

In an embodiment, the air channel has a hollow cylindrical structure, and is prepared from alumina ceramic powder via compression molding. The air channel is configured as air passage for vacuumization, and has excellent high-temperature chemical stability, and will not be oxidized during operation.

In an embodiment, the infrared nod temperature instrument is coaxially arranged on the second end of the air channel, which facilitates the accurate measurement of the temperature inside the air channel.

Compared to the prior art, the present disclosure has the following beneficial effects.

This application provides an electromagnetic-induction heating device, in which the ceramic blade is enveloped by the spiral coil; two ends of the spiral coil are both connected to the electromagnetic-induction heater; and the thin-film thermocouple is arranged on the surface of the ceramic blade. Under such arrangement, the heating device provided herein can heat the thin-film thermocouple to activate its thermoelectric properties with minimal effects on the CMC-SiC blade.

Moreover, the electromagnetic-induction heating device provided herein will not cause a large thermal effect on the ceramic blade while heating the thin-film thermocouple at high temperature, thus ensuring the service performance test accuracy of the ceramic blade.

Technical solutions of the present disclosure will be described in detail below with reference to the embodiments and accompanying drawings.

### BRIEF DESCRIPTION OF THE DRAWINGS

FIG. 1 is a schematic diagram of an electromagnetic-induction heating device according to an embodiment of the present disclosure;

FIG. 2 is a partial schematic diagram of a heating end of the electromagnetic-induction heating device according to an embodiment of the present disclosure; and

FIG. 3 shows coupling simulation results of the electromagnetic-induction heating device by using a COMSOL software according to an embodiment of the present disclosure.

In the drawings, 1, thin-film thermocouple; 2, ceramic blade; 3, spiral coil; 4, alumina ceramic chamber; 5, air channel; 6, infrared nod temperature instrument; 7, electromagnetic-induction heater; 8, controller; and 9, vacuum pump.

### DETAILED DESCRIPTION OF EMBODIMENTS

The technical solutions in the embodiments of the present disclosure will be clearly and completely described below with reference to the accompanying drawings. Described below are only some embodiments of the present disclosure, which are not intended to limit the disclosure. Based on the embodiments provided herein, all other embodiments obtained by one of ordinary skill in the art without paying creative work shall fall within the scope of the present disclosure.

It should be noted that the orientation or positional relationships indicated by terms, such as “center”, “longitudinal”, “traversal”, “up”, “down”, “front”, “behind”, “left”, “right”, “vertical”, “horizontal”, “top”, “bottom”, “inside”, “outside”, “side”, “end”, and “edge”, are based on the orientation or positional relationships shown in the accompanying drawings. These terms are merely intended to facilitate and simplify the description of the present disclosure, rather than indicating or implying that the device or element referred to must have a particular orientation, and be constructed and operate in a particular orientation. Therefore, these terms should not be construed as limitations to the present disclosure. Furthermore, unless otherwise stated, the term “a plurality of” used herein means two or more.

It should be noted that, unless otherwise expressly specified and limited, the terms, such as “arrangement”, “link”, and “connection”, should be understood in a broad sense. For example, the term “connection” can be a fixed connection, removable connection, or integral connection; a mechanical connection or electrical connection; and a direct connection or indirect connection through an intermediate medium, or internal communication of two components. For one of ordinary skill in the art, the specific meaning of the above terms in the following description can be understood in specific cases.

It should be understood that the terms “including” and “comprising” used herein indicate the presence of the described feature, whole, steps, operations, elements and/or components, but do not exclude the presence or addition of one or more other features, whole, steps, operations, elements, components and/or collections thereof.

In addition, the terms used herein are solely for describing particular embodiments and are not intended to limit the present disclosure. As used herein, the singular forms “one”, “a”, and “this”, unless otherwise clearly indicated, include the plural form.

Moreover, the term “and/or” as used herein refers to any and all possible combinations of one or more of the listed items, and includes such combinations.

Accompanying drawings illustrate various structural diagrams according to embodiments of the present disclosure. These drawings are not drawn to scale, in which certain details may be enlarged or omitted for clear presentation. The shapes of various zones and layers shown in the drawings and the relative size and position relationships are only exemplary. Zones/layers with different shapes, sizes, and relative positions can be designed by those skilled in the art according to the practical needs.

This application provides an electromagnetic-induction heating device for a thin-film thermocouple on a ceramic blade, which is capable of heating the thin-film thermocouple on the surface of the ceramic blade while avoiding the oxidation of the film thermocouple and the direct heating of the ceramic blade. In this case, it can avoid a large thermal effect on the ceramic blade during heating, thus ensuring the accuracy of subsequent service tests of the ceramic blade.

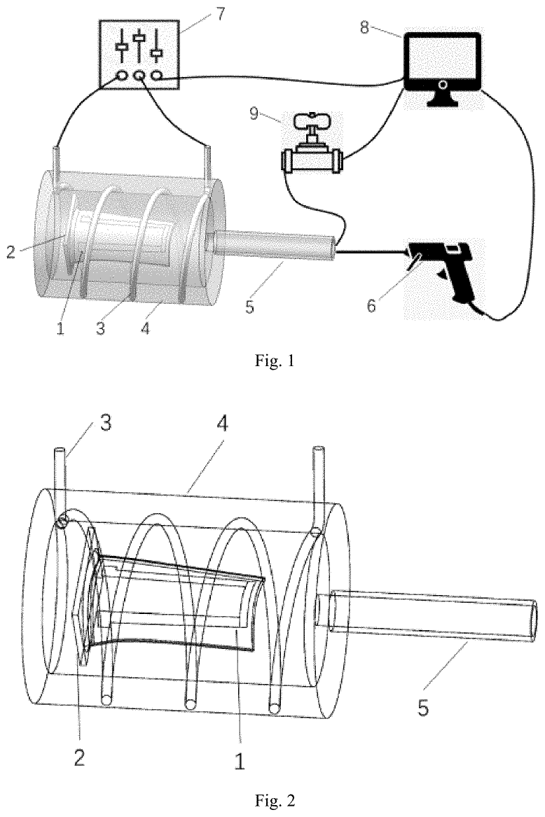

Referring to FIG. 1, an electromagnetic-induction heating device for a thin-film thermocouple on a ceramic blade is provided, which includes a thin-film thermocouple 1, a ceramic blade 2, a spiral coil 3, an alumina ceramic chamber 4, an air channel 5, an infrared nod temperature instrument 6, an electromagnetic-induction heater 7, a controller 8, and a vacuum pump 9.

The ceramic blade 2 is arranged in the alumina ceramic chamber 4. The thin-film thermocouple 1 is arranged on an upper surface of the ceramic blade 2. The spiral coil 3 is spirally arranged on the thin-film thermocouple. Two ends of the spiral coil 3 are both electrically connected to the electromagnetic-induction heater 7. The air channel 5 is arranged in a front end of the alumina ceramic chamber 4. The infrared nod temperature instrument 6 and the vacuum pump 9 are independently connected to the air channel 5. The controller 8 is electrically connected to the infrared nod temperature instrument 6, the electromagnetic-induction heater 7, and the vacuum pump 9.

The thin-film thermocouple 1 is prepared on the upper surface of the ceramic blade 2 via screen printing and is mainly made of tungsten rhenium alloy. The thickness of the thin-film thermocouple 1 is 100 μm±5%.

The ceramic blade 2 is a stator blade, which is mainly made of CMC-SiC. The curvature of the ceramic blade 2 is determined by engine types.

The ceramic blade 2 is enveloped in the spiral coil 3. The coil diameter of the spiral coil 3 is 5±0.2 mm. An axial length of the spiral coil 3 is the same with a length of the ceramic blade 2, and an inner diameter of the spiral coil 3 is offset such that the ceramic blade 2 is completely enveloped in the spiral coil 3. The gap between the spiral coil 3 and the ceramic blade 2 is 2±0.1 mm. The spiral coil 3 is arranged in the alumina ceramic chamber 4.

Referring to FIG. 2, the alumina ceramic chamber 4 is cylindrical. A length of the alumina ceramic chamber 4 is the same as the axial length of the spiral coil 3, and an inner diameter of the alumina ceramic chamber 4 is the same as an outer diameter of the spiral coil 3. The spiral coil 3 is embedded into the alumina ceramic chamber 4, and the spiral coil 3 and the alumina ceramic chamber 4 are integrally formed by pressing molding.

The air channel 5 is connected to a bottom surface of the alumina ceramic chamber 4 and has a hollow cylindrical structure with an outer diameter of 1 cm, an inner diameter of 5 mm, and a length of 20 cm±2%. The air channel 5 is made of alumina ceramic, which is prepared from alumina ceramic powder via compression molding.

The infrared nod temperature instrument 6 is coaxially arranged on one side of the air channel 5.

The electromagnetic-induction heater 7 is connected to the spiral coil 3 and has a power of 25 KW and a frequency of 50 Hz±2%, which is configured to provide the electromagnetic induction field for heating the thin-film thermocouple 1.

The controller 8 is connected to the electromagnetic-induction heater 7 and the infrared nod temperature instrument 6, and is configured to obtain the heating temperature signals and perform a proportional-integral-derivative (PID) control on the heating process. The vacuum pump 9 is connected to the air channel 5, and is configured to evacuate the alumina ceramic chamber 4.

The working principles of the aforementioned electromagnetic-induction heating device are described below.

The electromagnetic-induction heater 7 provides a source of alternating induction electromagnetic field for the spiral coil 3, rendering the thin-film thermocouple 1 to produce an induction eddy current for heating.

At the same time, the ceramic blade 2 is non-metal, which does not produce the induction eddy current for generating heat. Therefore, the ceramic blade is heated indirectly.

The vacuum pump 9 is configured to vacuumize the alumina ceramic chamber 4 through the air channel 5 to avoid the thin-film thermocouple 1 to be oxidized during the heat treatment process. The infrared nod temperature instrument 6 is configured to determine the temperature of the thin-film thermocouple 1 arranged on the surface of the ceramic blade 2 through the air channel 5, and provide parameters required for the PID control to the controller 8. Then the controller 8 is configured to make the electromagnetic-induction heater 7 to control the electric magnetic field and stable the heating temperature.

To make the objectives, technical solutions, and advantages of the present disclosure clearer, the technical solutions in the embodiments of the present disclosure will be described clearly and completely with reference to the accompanying drawings. The described embodiments are merely illustrative. Typically, the components in the embodiments and the accompanying drawings can be arranged and designed in various configurations. Therefore, the following detailed description is not intended to limit the scope of protection of the present disclosure defined by the appended claims, but only to indicate selected embodiments of the present disclosure. Based on the embodiments described herein, all other embodiments obtained by one of ordinary skill in the art without paying creative work shall fall within the scope of protection of the present disclosure.

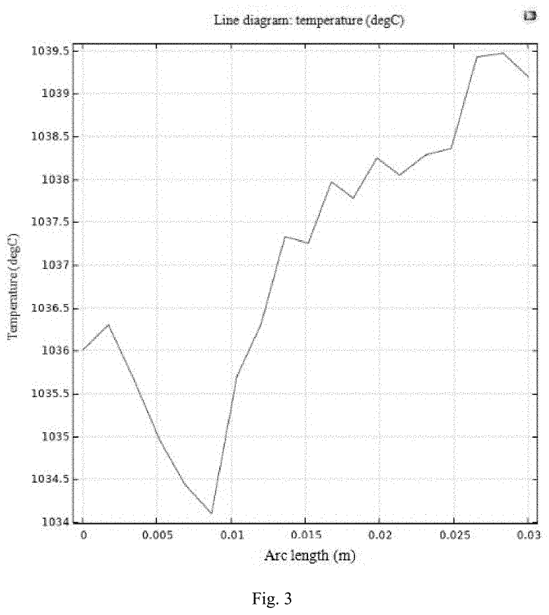

Referring to FIG. 3, the heating insulation effect of the aforementioned electromagnetic-induction heating device is measured and subjected to a coupling simulation by using a COMSOL software. The result shows that the uniformity of the heating temperature of the thin-film thermocouple is ±3° C. (namely, 1034-1040° C.) at an operating load of 1037° C. (1310K), indicating that the heating device provided herein has good insulation and temperature control performance and can achieve relevant functions.

In summary, beside heating the thin-film thermocouple on the surface of the ceramic blade, the electromagnetic-induction heating device provided herein can avoid the oxidation of the thin-film thermocouple and the direct heating of the ceramic blade, where the thin-film thermocouple is prepared via screen printing. It avoids a large thermal effect on the ceramic blade during heating, thus ensuring the accuracy of subsequent service tests of the ceramic blade. After the heat treatment on the tungsten rhenium alloy thin-film thermocouple prepared on the ceramic blade, it is free of oxidation, with the Seebeck coefficient about 12 μV/K and no significant thermal deformation on the blade.

Described above are merely illustrative of the technical idea of the present disclosure, and are not intended to limit the scope of the present disclosure. It should be understood that any changes, modifications and replacements made by those skilled in the art without departing from the spirit of the disclosure shall fall within the scope of the present disclosure defined by the appended claims.

What is claimed is:

1. An electromagnetic-induction heating device for a thin-film thermocouple on a ceramic blade, comprising:
a spiral coil;
an alumina ceramic chamber;
an air channel;
an infrared nod temperature instrument;
an electromagnetic-induction heater;
a controller; and
a vacuum pump;
wherein the ceramic blade is enveloped in the spiral coil; an axial length of the spiral coil is the same with a length of the ceramic blade, and an inner diameter of the spiral coil is offset such that the ceramic blade is completely enveloped in the spiral coil; a gap is provided between the spiral coil and the ceramic blade; the spiral coil is arranged in the alumina ceramic chamber; the spiral coil and the alumina ceramic chamber are integrally formed by pressing molding; two ends of the spiral coil are both connected to the electromagnetic-induction heater; the ceramic blade is arranged in the alumina ceramic chamber; the thin-film thermocouple is arranged on a surface of the ceramic blade; a first end of the air channel is connected to an end of the alumina ceramic chamber, and a second end of the air channel is connected to the infrared nod temperature instrument and the vacuum pump; and the electromagnetic-induction heater, the infrared nod temperature instrument and the vacuum pump are all electrically connected to the controller.

2. The electromagnetic-induction heating device of claim 1, wherein the gap between the spiral coil and the ceramic blade is 2±0.1 mm.

3. The electromagnetic-induction heating device of claim 1, wherein the alumina ceramic chamber is cylindrical; a length of the alumina ceramic chamber is the same as the axial length of the spiral coil, and an inner diameter of the alumina ceramic chamber is the same as an outer diameter of the spiral coil.

4. The electromagnetic-induction heating device of claim 1, wherein the ceramic blade is a stator blade made of ceramic matrix composite (CMC)-SiC.

5. The electromagnetic-induction heating device of claim 1, wherein the air channel has a hollow cylindrical structure, and is prepared from alumina ceramic powder via compression molding.

6. The electromagnetic-induction heating device of claim 1, wherein the infrared nod temperature instrument is coaxially arranged on the second end of the air channel.
